(19) United States
(12) Patent Application Publication
(10) Pub. No.: US 2020/0041328 A1
(43) Pub. Date: Feb. 6, 2020

(54) HYDRAULIC WEIGHT DETERMINATION

(71) Applicants: INS - Europe, Aakirkeby (DK); Tamtron Oy, Tampere (FI)

(72) Inventor: Torben Winther Hansen, Aakirkeby (DK)

(21) Appl. No.: 16/523,816

(22) Filed: Jul. 26, 2019

(30) Foreign Application Priority Data
Aug. 1, 2018 (DK) PA 2018 00435

(51) Int. Cl. G01G 5/04; B66F 9/075; G01G 19/10; B66F 9/22; G01G 19/08

(52) U.S. Cl. CPC G01G 5/04; B66F 9/0755; G01G 19/083; B66F 9/22; G01G 19/10

(57) ABSTRACT

A method and device for weight determination of a load lifted by an actuator in a hydraulic lifting device are disclosed. A pressure signal is generated using a pressure gauge, a deviation signal is generated based on a flow signal and a setpoint, and a regulation signal is generated based on the deviation signal to regulate the actuator. An inclination signal is generated using an inclination gauge. The weight of the load is determined based on the pressure signal, the deviation signal, the regulation signal, and the inclination signal.

### CROSS-REFERENCE TO RELATED APPLICATION

This application claims the benefit of Danish Patent Application No. PA 2018 00435, filed 1 Aug. 2018 by the present Applicants, and entitled “HYDRAULIC WEIGHT DETERMINATION,” the entirety of which is incorporated by reference herein.

### BACKGROUND

The present disclosure relates to a method and a weighing device for weight determination of a load lifted by a hydraulic lifting device, such as a forklift truck, front loader or telescopic loader, and which comprises a hydraulic actuator to perform the lifting action.

Weight determination of the above nature is used in connection with transportation of for example goods, sand and stones. Weighing systems are mounted on various devices such as forklift trucks, front loaders and telescopic loaders whereby the weight of the cargo can be determined without driving to a remote stationary weighing system. In some known methods, weight determination is performed while the hydraulic lifting device is moving in order to reduce the friction of bearings, sliding surfaces and actuators, since dynamic friction is lower than static friction.

In a known method, DK 2016 70282 (A1), weight determination of a load is performed using at least one upward and one downward displacement of the lifting device where the lifter is displaced by means of a hydraulic actuator in a hydraulic system. The hydraulic flow in the hydraulic system is limited by a two-way flow control. A pressure signal and a position signal are generated, and the weight determination is performed based on these.

In another known method, DE4328148 (A1), this is performed in a hydraulic forward flow or a hydraulic return flow with the result that the lifting device is either lifted or lowered at an even speed while recording the weight of the load. As a disadvantage of this method, the measuring accuracy is relatively poor since measuring errors of up to between ±1% and ±2% of the lifting capacity of the lifting device have to be allowed for. The reason for this relatively pronounced inaccuracy is the mechanical friction in the lifting device which consumes part of the force exerted by the load and also changes from one hour to the next. A hydraulic pressure drop is generated inside the hydraulic tubing between the actuator and the pressure gauge as a result of the flow, which contributes with additional measuring errors. Ibis pressure drop changes with the magnitude of the flow and the viscosity of the hydraulic medium which is dependent on the temperature of the medium. Because hydraulic systems generate heat, the viscosity of the medium and thereby the accuracy of the weight determination depend on various factors such as the duration of the operating period for the lifting device.

A third known method, EP1893955 (B1), uses measurement of the pressure and the flow when the load is lifted and lowered, respectively, and thereby balances the error sources that change the operational sign with the direction of the actuator displacement and by compensating for the differing and varying displacement speeds of the actuator. Due to the viscosity changes in the hydraulic medium, obtaining an appropriate and reliable weighing accuracy remains a challenge. Furthermore, hydraulic lifting devices are often used with vehicles that are not positioned on a horizontal base, which generates weighing errors as a result of the inclination of the lifting device relative to the direction of gravity.

### SUMMARY

This disclosure provides a method that will considerably reduce weighing errors by regulating and maintaining a constant and identical actuator displacement speed in both directions and in particular by generating a deviation-dependent signal which ensures that pressure measurements are recorded only under the conditions mentioned, which eliminates weighing errors as a result of acceleration forces and weighing errors as a result of changes in the hydraulic medium viscosity due to its varying temperature. This method also compensates for the inclination of the lifting device relative to the direction of the gravity as a result of the characteristics of the base or tilting of the lifting device in case of heavy loads. As a result of the benefits mentioned, a weighing accuracy in the order of ±0.1% of the lifting capacity of the lifting device can be achieved, even under less favourable conditions.

According to the principles described herein, this is achieved by recording a deviation-dependent parameter for the actuator displacement speed, by regulating the actuator speed by means of a regulation parameter, by recording an inclination-dependent parameter, and by determining the weight as dependent on the deviation-dependent parameter and on a regulation parameter for the actuator regulation and on the inclination-dependent parameter.

The principles described herein are based on the physical law that the mechanical friction between two surfaces is a force which will seek to prevent movement and which is proportional to the normal force with which the two surfaces impact on each other and is unrelated to the size of the surfaces. As a result of this, the direction of the friction is opposite to the direction of movement exerted by the surfaces. The principles described herein are also based on the physical law that the size and direction of a hydraulic pressure drop in a tube which contains a flow, also depends on the magnitude and direction of the flow.

Provided the actuator displacement takes place at a constant and identical speed (via a variable pump or other form of flow regulator), this means that the friction and pressure drop resulting from the actuator displacement are identical in both directions but that the operational signs change with the direction of displacement. The operational sign of the force exerted by the load remains the same, however, even though the direction of the actuator displacement changes.

Consequently, through multiplication with a proportionality constant half the sum of the recorded pressure values, measured via a pressure gauge during the upward and subsequent downward movement of the actuator, is an expression of the weight of the load and the lifted components of the lifting device. Since the friction values are identical for both directions although opposites, their sum is zero, which also applies to the pressure drop in the tubing where the sum of the pressure drop is zero. In order to ensure accurate weight determination, the actuator displacement speed must be regulated and stay constant and of the same magnitude in both directions and there must be a signal that, when the deviation is sufficiently small, alerts the display unit to start recording the pressure exerted by the actuator.

When the system is in a neutral position, the weight determination function is not active. In this position, the hydraulic flow merely passes through the system using the flow route indicated by the unbroken line whereby the hydraulic lifting device can be used as is customary.

When the system is in a weighing position, the weight determination procedure is performed; for this procedure the load, which is lifted by the actuator, is subjected to at least one upward and one downward displacement and the hydraulic pressure in the actuator is measured by means of a pressure gauge. The weighing procedure is initiated by activation of the display unit; this supplies a solenoid with current thereby closing a bypass valve and this establishes a flow route marked by the unbroken line. Following this, a flow equivalent to at least the magnitude of a flow as set by means of a pre-defined setpoint is fed to the hydraulic lifting device. As a result of this, the flow passes into the tubing through a flow regulator and through the flow gauge to an actuator that lifts the load. If the flow fed is larger than the flow set using the setpoint, the excessive flow will pass through a pressure relief valve and return to the tank, which reduces the power loss in the flow regulator when the load is lifted.

During the displacement of the actuator a flow signal proportional to the actuator displacement speed is sent to a summation point where the flow signal is compared with the setpoint flow which is equivalent to a given actuator displacement speed. This provides a deviation-dependent signal which via a process unit controls that the flow regulator maintains the displacement speed set in the setpoint. The deviation-dependent signal is transmitted to the display unit and here used as a criterion to determine when a constant and desired actuator speed has been reached and when the display unit should start recording the pressure in the actuator, When the criterion has been met, the display unit records the pressure for a few seconds and then demands the load to be lowered, whereby the flow returns from the actuator along the same route as during the lift, only in the opposite direction.

During the lowering procedure, the actuator displacement speed is controlled in the same manner as during the lifting procedure; the flow signal, however, changes operational sign which can be allowed for in various ways. After a period of time equivalent to the one for the lifting procedure, the display unit has recorded the pressure for the actuator displacement in both directions and the display unit can now perform the weight determination procedure.

During the above weighing process, the actuator inclination, which is preferably part of the weight determination, is recorded, The actuator position is detected by a position gauge which gives a position signal to be used in the weight determination. As an example, the hydrostatic pressure generated by the hydraulic medium depends on the position of the actuator, and on forklift trucks the varying length of chains and hydraulic tubing contributes to the pressure generated by the load. Using a position signal, the above error sources can be eliminated.

In order to avoid unnecessary power consumption, a pressure relief system has been introduced to reduce the hydraulic pressure during the upward actuator displacement action. If the flow fed when lifting the load is larger than necessary in order to obtain the lifting speed defined using the setpoint, the excess flow will return to the tank through a pressure relief valve at exactly the pressure necessary to lift the load. Especially for heavy loads, natural oscillations (second order components) in the lifting device are a problem. This problem is solved by detecting variations in either the pressure signal or the inclination signal and waiting to complete the weighing process until the oscillations have stopped.

Since the temperature in the hydraulic system is of significance, among others for the accuracy of the pressure gauge, temperature variations are measured and compensated for by means of a temperature gauge which might form an integral part of the pressure gauge. To determine the dead load of various components of the lifting device, for example the actuator piston rod, a special weight determination procedure is performed without load (resetting); this is done only once. In subsequent weight determination procedures, the above dead load is subtracted from the weighing result obtained in the weight determination of the load.

In a special method for weight determination, a parameter, which is dependent on the position of the actuator, is measured by means of a position gauge. This compensates for position-dependent erroneous contributions, for example from variations in the length and weight of chains and tubing in the lifting device.

In another method for weight determination, a pressure relief system is introduced to reduce the pressure and power consumption during actuator displacement in upward direction. During the displacement of the actuator, the flow is fed into the tubing, passes to a flow regulator and through the flow gauge to an actuator that lifts the load. If the flow fed is larger than the flow value set using the setpoint, the excessive flow will pass through a pressure relief valve and return to the tank, which gives maximum reduction of the loss in power consumption.

In a method for weight determination, an oscillation-dependent parameter for dampened oscillations in the lifting device is measured by means of a pressure gauge or an inclination gauge. Based on this oscillation-dependent parameter recording of the actuator pressure awaits until the oscillations have been reduced sufficiently to avoid interfering weight contributions.

In a method for weight determination a temperature-dependent parameter is measured via the hydraulic medium by means of a temperature gauge, which can form an integral part of the pressure gauge. Based on the temperature-dependent parameter, temperature-dependent measuring errors are compensated for.

For the example of the weighing device comprising a display unit containing a processor for weight determination of a load lifted by an actuator, the weight determination is based on displacement of the actuator in both directions, where a hydraulic pressure signal is measured, and where a deviation signal to regulate the displacement of the actuator is generated via a flow signal, a setpoint and a summation point, and where the inclination of the actuator is measured, and where the pressure measured in the actuator is compensated for this inclination, and where the display unit is designed to record a deviation signal for the actuator speed to determine when to record the pressure measurements. This produces an exceptionally high weighing accuracy in the order of ±0.1% of the lifting capacity of the lifting device.

In one example of the weighing device, where the actuator position is determined in one or more points by means of a position gauge and via one or more position sensors, the position measurement is based on either magnetic, inductive, optic or ultrasonic principles whereby several ways of compensating for position-dependent weighing errors are achieved.

In another example of the weighing device, a pressure relief valve is present which reduces the hydraulic pressure and the power consumption such that only the pressure required to perform the weight determination is maintained whereby the power consumption is minimised.

In an example of the weighing device where the natural oscillations of the lifting device are detected via oscillations of the pressure signal or the inclination signal, recording of the actuator pressure awaits until the oscillations in the lifting device have seized, whereby interference with the weighing accuracy is avoided.

In an example of the weighing device where the temperature of the hydraulic medium is measured by a temperature gauge and where the pressure gauge is exposed to temperature variations, for example via the ambient environment or heated hydraulic medium, temperature-dependent measuring errors generated by the pressure gauge are compensated for whereby an improvement of the temperature stability is achieved.

### BRIEF DESCRIPTION OF THE DRAWINGS

Examples of the principles of the present disclosure will be explained with reference to the accompanying drawings, of which:

FIG. 1 is a diagram of a system for hydraulic weight determination in a neutral position in which a weight determination function is not in operation and where a lifting device is used in the customary way; and

FIG. 2 is a diagram of a system for hydraulic weight determination in a weighing position in which a weight determination is performed together with a hydraulic lifting device comprising an actuator carrying a load.

### DETAILED DESCRIPTION

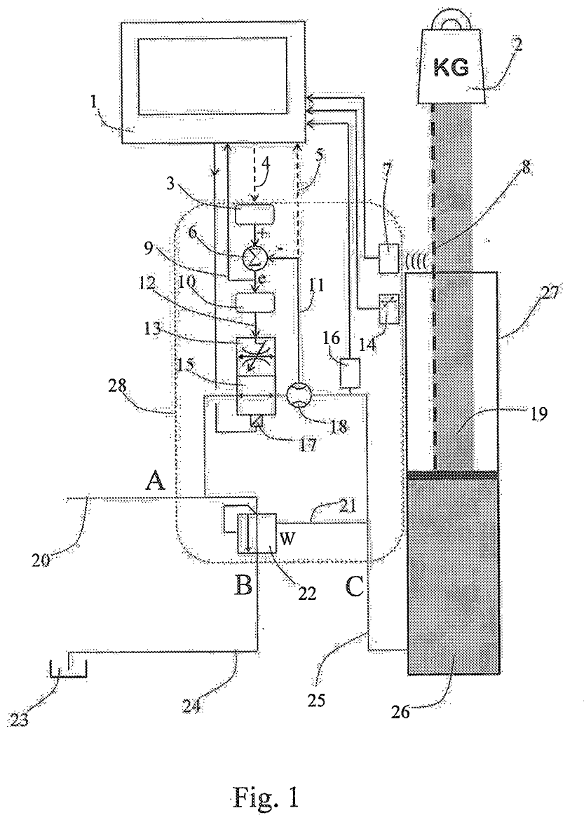

FIG. 1 is a diagram of a system for hydraulic weight determination in a neutral position in which a weight determination function is not in operation and where a lifting device is used in the customary way. In the neutral position in FIG. 1, the weight determination function is not in operation whereby the flow 20 merely passes through the tubing of the system along the flow route marked by the unbroken line. As a result of this, the flow 20 enters the tubing through a bypass valve 15 and through a gauge 18 measuring the flow to an actuator 27 whereby the load 2 is lifted.

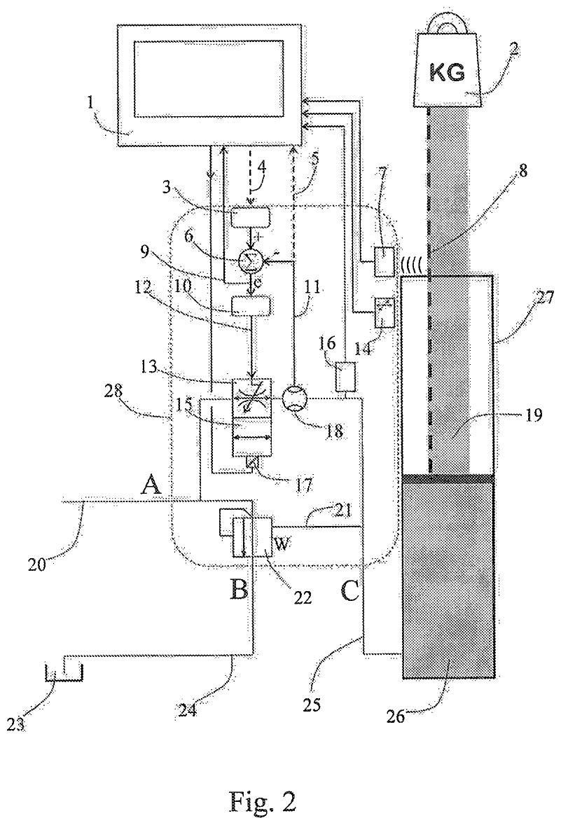

FIG. 2 is a diagram of a system for hydraulic weight determination in a weighing position in which a weight determination is performed together with a hydraulic lifting device comprising an actuator carrying a load. In the weighing position in FIG. 2, the weight determination procedure relies on the circumstance that the load 2, which is lifted by the actuator 27, is subjected to at least one upward and one downward displacement and that the hydraulic pressure in the actuator 27 is measured by means of a pressure gauge 16.

The weighing procedure is initiated by activation of the display unit 1, which supplies a solenoid 17 with current thereby closing the bypass valve 15; this establishes a flow route marked by the unbroken line. Following this, a flow 20 equivalent to at least the magnitude of a flow as set by means of a pre-defined setpoint 3 is fed to the hydraulic lifting device. As a result of this, the flow passes into the tubing through a flow regulator 13 and through the flow gauge 18 to an actuator 27 that lifts the load 2. If the flow fed is larger than the flow set using the setpoint 3, the excessive flow 24 will pass through a pressure relief valve 22 and return to the tank 23, which reduces the power loss in the flow regulator 13 when the load 2 is lifted.

During the displacement of the actuator 27 a flow signal 11 proportional to the actuator displacement speed is sent to a summation point 6 where the flow signal 11 is compared with the setpoint 3 flow which is equivalent to a given actuator displacement speed. Thereby a deviation-dependent signal 9 is generated which via a process unit 10 and a regulation signal 12 controls that the flow regulator 13 maintains the actuator displacement speed which is set by the setpoint 3. In an alternative example, where connections 4 and 5 are established, parts of or the entire regulation circuit, consisting of 3, 6 and 10, can be performed by the display unit 1. The deviation-dependent signal 9 is transmitted to the display unit 1, where it is used as a criterion to determine when a constant and desired actuator speed has been reached and when the display unit 1 should start recording the hydraulic pressure. When the criterion has been met, the display unit 1 records the pressure for a few seconds and then demands the load 2 to be lowered, whereby the flow 25 returns from the actuator 27 along the exact same route as during the lift, only in the opposite direction.

During the lowering procedure, the actuator displacement speed is controlled in the same manner as during the lifting procedure; the flow signal 11, however, changes operational sign which can be allowed for in various ways. After a period of time equivalent to the one for the lifting procedure, the display unit 1 has recorded the pressure for the actuator displacement in both directions and the display unit 1 can now perform the weight determination procedure. During the above weighing process, the inclination of the actuator 27 is recorded via a dual-axis inclination gauge 14 and an inclination signal is generated which is used in the weight determination in order to render it more accurate.

Improvement is achieved through a process whereby a position gauge 7 detects the position of the actuator 27 via one or more position sensors 8 and generates a position signal which is used in the weight determination. As an example, the hydrostatic pressure generated by the hydraulic medium 26 depends on the position of the actuator, and on forklift trucks the varying length of chains and hydraulic tubing contributes to a variable pressure, in addition to the pressure generated by the load 2. In another method, the weight determination always starts at the same actuator position which can be performed by means of a simple position gauge in only a single point. Using the position-dependent signal, the above error contributions can be determined and eliminated.

Another improvement has been achieved by introducing a pressure relief valve 22, which reduces the hydraulic pressure thereby avoiding unnecessary power consumption during upward actuator displacement. If the flow fed when lifting the load 2 is larger than necessary in order to obtain the lifting speed defined using the setpoint 3, the excess flow 24 will return to the tank 23 through a pressure relief valve 22 at exactly the pressure necessary to lift the load 2 and defined by the pilot pressure 21.

One more improvement has been achieved in that natural oscillations in the lifting devices are detected, either via variations in the signal from the pressure gauge 16 or from the inclination gauge 14, in order to postpone the weighing process until the oscillations have stopped. The weighing accuracy is improved by measuring and compensating for temperature changes in the hydraulic system. The temperature is measured via a temperature gauge which may form an integral part of the pressure gauge 16. This way, temperature-dependent measuring errors produced by the pressure gauge can be reduced considerably.

To determine the dead load of various components of the lifting device, for example the actuator piston rod 19, a special weight determination procedure is performed without load resetting; this is done only once. In subsequent weight determination procedures, the above dead load is subtracted thereby producing the weight of the load.

The system comprising components 28, a display unit 1 and a position sensor 8 can either be provided in a single unit or be decentralised such that certain components of the system, such as flow regulator 13, pressure relief valve 22 or similar, can form part of the structure of the hydraulic lifting device.

A skilled person would be able to apply the principles described herein by following these instructions and on their own develop functions to realise variants of the principles described herein.

1. A method for weight determination of a load lifted by an actuator, comprising:
performing at least one upward displacement of the actuator and at least one downward displacement of the actuator, wherein displacing the actuator comprises initiating a flow in a hydraulic tubing system of the actuator;
generating a pressure signal based on a hydraulic pressure in the hydraulic tubing system, wherein the hydraulic pressure is determined using a pressure gauge;
generating a deviation-dependent parameter via a flow signal and a setpoint, wherein the flow signal is based at least in part on a displacement speed of the actuator;
generating a regulation parameter based at least in part on the deviation-dependent parameter;
determining a weight of the load based at least in part on the deviation-dependent parameter and the regulation parameter; and
outputting the weight of the load.

2. The method according to claim 3, further comprising determining a position-dependent parameter of the actuator using a position gauge and a position sensor, wherein determining the weight of the load is further based at least in part on the position-dependent parameter of the actuator.

3. The method according to claim 1, further comprising performing controlling a pressure relief system to reduce pressure and power consumption, and wherein the weight determination is performed using the pressure relief system to reduce the power consumption.

4. The method according to claim 3, further comprising determining an oscillation-dependent parameter based on a pressure signal or an inclination signal, wherein determining the weight of the load is further based at least in part on the oscillation-dependent parameter.

5. The method according to claim 1, further comprising determining a temperature-dependent parameter based at least in part on a hydraulic fluid temperature, wherein determining the weight of the load is further based at least in part on the temperature-dependent parameter.

6. The method according to claim 1, further comprising measuring an actuator inclination relative to a direction of the gravity to determine an inclination-dependent parameter, and wherein determining the weight of the load is further based at least in part on the inclination-dependent parameter.

7. A weighing device comprising:
an actuator comprising a hydraulic tubing system;
a pressure gauge; and
a processor configured to:
initiate a flow in a hydraulic tubing system of the actuator, wherein displacing the actuator comprises initiating a flow in a hydraulic tubing system of the actuator;
generate a pressure signal based on a hydraulic pressure in the hydraulic tubing system using the pressure gauge;
generate a deviation-dependent parameter via a flow signal and a setpoint, wherein the flow signal is based at least in part on a displacement speed of the actuator;
generate a regulation parameter based at least in part on the deviation-dependent parameter;
determine a weight of the load based at least in part on the deviation-dependent parameter and the regulation parameter; and
output the weight of the load.

8. The weighing device according to claim 7, further comprising:
a position gauge and a position sensor configured to measure a position-dependent parameter of the actuator; wherein the processor is configured to determine the weight of the load further based at least in part on the position-dependent parameter.

9. The weighing device according to claim 7, further comprising:
a pressure relief valve configured to reduce actuator pressure and power consumption.

10. The weighing device according to claim 7, wherein the processor is further configured to determine an oscillation-dependent parameter based on a pressure signal or an inclination signal, wherein determining the weight of the load is further based at least in part on the oscillation-dependent parameter.

11. The weighing device according to claim 7, further comprising a temperature sensor, wherein the processor is further configured determine a temperature-dependent parameter based at least in part on a hydraulic fluid temperature using the temperature sensor, wherein determining the weight of the load is further based at least in part on the temperature-dependent parameter.

12. The weighing device according to claim 7, further comprising an inclination gauge configured to measure an actuator inclination relative to a direction of gravity to generate an inclination signal, and wherein the processor is configured to record the inclination signal and perform the determining of the weight based at least in part on the inclination signal.
